(19) United States
(12) Patent Application Publication
(10) Pub. No.: US 2010/0115784 A1
(43) Pub. Date: May 13, 2010

(54) MULTIPLE LAUNDRY TREATING MACHINE AND CONTROL METHOD THEREOF

(75) Inventors: Seong Jin Jo, Changwon-si (KR); Seong Hae Jeong, Changwon-si (KR); Deua Hee Lee, Changwon-si (KR)

Correspondence Address: MCKENNA LONG & ALDRIDGE LLP, 1900 K STREET, NW, WASHINGTON, DC, 20006, US

(73) Assignee: LG ELECTRONICS INC., Seoul (KR)

(21) Appl. No.: 12/309,692

(22) PCT Filed: Jul. 26, 2007
(86) PCT No.: PCT/KR2007/003587

§ 371 Date: Jan. 15, 2010

(30) Foreign Application Priority Data
Jul. 28, 2006 (KR) 10-2006-0071364
Jul. 28, 2006 (KR) 10-2006-0071366

(51) Int. Cl. D06F 58/04; F26B 25/06; G05D 7/00; F26B 25/08

(52) U.S. Cl. 34/132; 34/218; 700/282; 34/202; 34/239

(57) ABSTRACT

The present invention relates to a multiple laundry treating machine and a control method thereof. The multiple laundry treating machine includes a body (110) formed with a laundry holding part (40) for holding laundry, an supplemental body (120) provided at one side of the body (110), the supplemental body (120) having a volume and a height respectively smaller than a volume and a height of the body (110), and having a space (122) defined in the supplemental body (120) to hold laundry, and an air supply unit provided in the body (110), to supply air to an interior of the body (110) and an interior of the supplemental body (120).

### TECHNICAL FIELD

The present invention relates to a multiple laundry treating machine and a control method thereof, and more particularly, to a multiple laundry treating machine configured by combining an supplemental laundry treating device to a general laundry treating machine, to have a convenience in use, and a control method thereof.

### BACKGROUND ART

Generally, a laundry treating machine means an apparatus for washing, drying, or washing and drying laundry, etc. One laundry treating machine can perform only a washing function or a drying function or can perform both the washing and drying functions. Recently, a laundry treating machine, which includes a steam supply unit, to have a refresh function for, for example, removal of creases, odor, static electricity, etc. from laundry, has been available.

Meanwhile, conventional laundry treating machines are classified into a front loading type and a top loading type in accordance with the direction that laundry is taken out. Also, conventional laundry treating machines are classified into a vertical-axis type, in which a pulsator or a washing tub rotates, and a horizontal-axis type, in which a drum rotates. The representative example of such a horizontal-axis type laundry treating machine is a drum washing machine or a drum drying machine. For such a drying machine, there is a cabinet type drying machine. In the cabinet type drying machine, laundry is dried in a cabinet in a state of being hung on a hanger.

Such laundry treating machines have a tendency to have a large size, in order to meet the recent demand of users. That is, laundry treating machines used for domestic purposes have a tendency to have a large outer size.

Meanwhile, drying machines are classified into an exhaustion type and a condensation type. In the exhaustion type drying machine, hot air is supplied to the interior of a drum, so that moisture-containing air is generated. The moisture-containing air is exhausted out of the drum, so that a drying effect is generated in the drum. Thus, there is no air circulation path in the exhaustion type drying machine. On the other hand, in the condensation type drying machine, hot air is supplied to the interior of a drum, so that moisture-containing air is generated. The moisture-containing air is treated to remove moisture therefrom. The resultant air is heated, and is then again supplied to the interior of the drum. Accordingly, a drying effect is generated in the drum. Thus, there is an air circulation path in the condensation type drying machine.

The condensation type drying system can be easily applied to a drying machine having a washing function (hereinafter, referred to as a “washing/drying machine”). In this regard, generally, drying machines having a washing function employs the condensation type drying system. In the condensation type drying system, moisture-containing air is cooled to condense the moisture contained in the air, and thus to remove the moisture. For such a condensation system, generally, an air cooling system or a water cooling system is used.

Where laundry treating machines having a drying function, such as drying machines or drying machines having a washing function, have a large size, there may be a problem in terms of saving of energy because they are driven in a large capacity even when a small amount of laundry is dried. On the other hand, in drum type laundry treating machines, there is a problem in that it is difficult to dry shoes or clothes. Of course, it may be possible to dry shoes, etc. by installing a rack in a drum, to lay the shoes on the rack, and maintaining the rack in a horizontal state, irrespective of a rotation of the drum. In this case, however, there is an inconvenience because the user should frequently perform the installation and separation of the rack.

FIG. 1 is a perspective view illustrating a conventional laundry treating machine.

As shown in FIG. 1, the conventional laundry treating machine 1 includes a body 10 forming the outer structure of the laundry treating machine 1, and a control panel 11 provided at the front surface or top surface of the body 10. The control panel 11 may include a controller for controlling the operation of the laundry treating machine 1. In accordance with this configuration, the user enables the laundry treating machine 1 to perform a washing operation or a drying operation by manipulating the control panel.

The conventional laundry treating machine 1 may be a washing machine, a drying machine, or a washing/drying machine.

The conventional laundry treating machine 1 may further include a base 20 for supporting the body 10 on a floor. The body 10 is laid on the base 20.

Generally, the base 20 is defined with a certain space therein. The space has a structure including a drawer 21, which can be forwardly drawn. The base 20 not only supports the body 10, but also functions as a storage box for storing a detergent or laundry.

In the conventional laundry treating machine, however, the base 20 does not have any function for treating laundry.

### DISCLOSURE OF INVENTION

### Technical Problem

An object of the present invention is to provide a multiple laundry treating machine capable of treating a small amount of laundry without driving the laundry treating machine in a large capacity, thereby achieving a convenience in use while saving energy.

Another object of the present invention is to provide a multiple laundry treating machine, which can be easily implemented using a conventional laundry treating machine and a base included in the conventional laundry treating machine.

Another object of the present invention is to provide a multiple laundry treating machine capable of easily drying laundry including shoes, hats, etc. which are difficult to be dried using a conventional drum type drying machine or a conventional washing/drying machine.

Still another object of the present invention is to utilize an supplemental space defined in a conventional laundry treating machine, such as a base, as an supplemental laundry treating device, and in particular, to enable a drying or refresh operation through the supplemental space.

### Technical Solution

The object of the present invention can be achieved by providing a multiple laundry treating machine comprising: a body formed with a laundry holding part for holding laundry; an supplemental body provided at one side of the body, the supplemental body having a volume and a height respectively smaller than a volume and a height of the body, and having a space defined in the supplemental body to hold laundry; and an air supply unit provided in the body, to forcibly supply air to the laundry holding part and to the space of the supplemental body, and to remove moisture from air.

The multiple laundry treating machine may further comprise a steam supply unit provided in the body, to supply steam to the laundry holding part and the space of the supplemental body.

The body may be a body of a generally drying machine or a body of a washing/drying machine. The drying machine body or washing/drying machine body may be provided with means for communicating the body with the supplemental body. The laundry holding part, which is provided in the body, to hold laundry, may be a drum included in a drum type drying machine or a washing/drying machine. In this case, the drum may be selectively rotatable.

The air supply unit may comprise a blowing fan for blowing air, a heater for heating air. Where a condensation type drying system is used, the air supply unit may further comprise a condensing unit.

The condensing unit may comprise a condensing passage, and a condenser for condensing moisture in the condensing passage. The condenser may be an air-cooling type condenser or a water-cooling type condenser.

The multiple laundry treating machine may further comprise means for communicating the body and the supplemental body. In this connection, the multiple laundry treating machine may further comprise a joining means for coupling the supplemental body to one side of the body. The supplemental body may be provided at a top, bottom, or one side of the body.

The supplemental body may be a base for supporting the bottom of the body on a floor. The supplemental body may be provided with a drawer capable of being forwardly drawn at a front side of the supplemental body. In this case, the laundry-holding space of the supplemental body may be an internal space of the drawer.

The air supply unit may comprise a drying passage and an supplemental drying passage for guiding air to be introduced into the laundry holding part and the laundry-holding space of the supplemental body, respectively. As described above, the laundry holding part may be a drum, and the laundry-holding space of the supplemental body may be an internal space of a drawer.

The supplemental drying passage may be branched from the drying passage. In this case, the heater may be provided in the drying passage upstream of a branching point of the supplemental drying passage. In accordance with the heater position, it is possible to heat air introduced into the drum and drawer, using one heater.

Dampers may be provided in the drying passage and the supplemental drying passage, respectively, to open/close the drying passage and the supplemental drying passage. This configuration is effective because, in the multiple laundry treating machine according to the present invention, it is necessary to forcibly introduce air only into the drum, or to forcibly introduce air only into the drawer. Of course, this configuration is effective in the case in which it is necessary to forcibly introduce air into the drum and drawer in a simultaneous or sequential manner.

The supplemental body may be formed with an inlet connected to the supplemental drying passage, to allow air to be introduced into the laundry-holding space. Accordingly, the supplemental body and the body communicate with each other via the supplemental drying passage and inlet.

The air supply unit may comprise an air discharge passage for guiding air to be discharged out of the laundry holding part, for example, a drum. In this case, the blowing fan may be provided in the air discharge passage. The air discharge passage may directly communicate with the outside of the body, to discharge air to the outside of the body.

Where a condensation type drying system is used, the air discharge passage may be connected to the condensing passage. That is, it is preferred to guide humid air introduced through the air discharge passage to the condensing passage, and thus to remove moisture from the air in the condensing passage.

The supplemental body may be formed with an outlet for discharging air out of the laundry-holding space, for example, the interior of a drawer. Of course, the outlet may directly communicate with the outside of the supplemental body, to discharge air to the outside of the supplemental body.

Alternatively, the air supply unit may comprise an supplemental air discharge passage connected to the outlet, to guide air to be outwardly discharged. The supplemental air discharge passage may be branched from the air discharge passage. Accordingly, it is possible to outwardly discharge air present in the interior of the drawer via the supplemental air discharge passage and outlet, without directly discharging the air out of the drawer. In this case, the body and supplemental body communicate with each other via the supplemental air discharge passage and outlet. The blowing fan may be provided in the air discharge passage downstream of the branching point of the supplemental air discharge passage. In this case, it is possible to supply air to the interior of the drawer while outwardly discharging the supplied air, using only one blowing fan.

Where a condensation type drying system is used, the supplemental air discharge passage may be connected to the condensing passage. That is, it is preferred to guide humid air introduced through the supplemental air discharge passage to the condensing passage, and thus to remove moisture from the air in the condensing passage. The supplemental air discharge passage may be branched from the air discharge passage.

The drawer may be provided with a rack provided in the drawer to allow laundry to be seated on the rack. The rack partitions the interior of the drawer into upper and lower spaces communicating with each other.

The multiple laundry treating machine may further comprise a controller for controlling the air supply unit to selectively supply air to the laundry holding part and to the interior of the supplemental body. The controller may comprise a control panel operated by the user. The control panel may be provided at the top of the body or the front surface of the body.

The controller may perform a control operation to vary the temperature and supply time of the air supplied to the interior of the supplemental body in accordance with an operation mode selected by a user.

In another aspect of the present invention, provided herein is a method for controlling a multiple laundry treating machine including a body provided with a selectively-rotatable drum, and an supplemental body provided at one side of the body, the supplemental body having a volume and a height respectively smaller than a volume and a height of the body, and having a space defined in the supplemental body to hold laundry.

The control method may comprise a first step of forcibly supplying air to the drum, and a second step of forcibly supplying air to the laundry-holding space. Of course, the laundry-holding space may be the interior of a drawer. The first and second steps may be simultaneously executed, or may be selectively executed.

The control method may further comprise a step of supplying steam to the laundry-holding space before or during the execution of the step of forcibly supplying air to the laundry-holding space, in accordance with an operation mode selected by the user.

The temperature and supply time of the air supplied to the interior of the supplemental body may be varied in accordance with the operation mode selected by the user.

The operation mode may comprise a shoes drying mode and a clothes drying mode.

It is preferred that, when the user selects the shoes drying mode, high-temperature air be supplied for a short period of time at the second step. On the other hand, it is preferred that, when the user selects the clothes drying mode, air having a relatively low temperature be supplied for a relatively long period of time at the second step.

Thus, in accordance with the present invention, it is possible to wash laundry using the drum included in the body and to dry a large amount of laundry using the drum, while drying a small amount of laundry using the internal space of the drawer included in the supplemental body. Accordingly, it is possible to achieve a convenience in use while saving energy. It is also possible to easily dry laundry including shoes, hats, etc. which are difficult to be dried using a conventional drum type drying machine.

### BRIEF DESCRIPTION OF THE DRAWINGS

The accompanying drawings, which are included to provide a further understanding of the invention, illustrate embodiments of the invention and together with the description serve to explain the principle of the invention.

In the drawings:

FIG. 1 is a perspective view illustrating a conventional laundry treating machine including a base;

FIG. 2 is a perspective view illustrating an outer structure of a multiple laundry treating machine according to a preferred embodiment of the present invention;

FIG. 3 is an exploded perspective view of an supplemental body shown in FIG. 2;

FIG. 4 is an exploded perspective view of a body shown in FIG. 2;

FIG. 5 is a sectional view of a steam supply unit shown in FIG. 2;

FIGS. 6 and 7 are sectional views illustrating an internal configuration of a multiple laundry treating machine according to a first embodiment of the present invention; and

FIG. 8 is a sectional view illustrating an internal configuration of a multiple laundry treating machine according to a second embodiment of the present invention.

### BEST MODE FOR CARRYING OUT THE INVENTION

The present invention now will be described more fully hereinafter with reference to the accompanying drawings, in which preferred embodiments of the invention are shown. The body of a multiple laundry treating machine according to the present invention may have the same structure as that of a general drying machine or a washing machine having a drying function (hereinafter, referred to as “a washing/drying machine”). Of course, a large part of the elements provided in the body may be identical to those of the general drying machine or washing/drying machine. Accordingly, no detailed description will be given of the same configuration as the general drying machine or washing/drying machine having a general drying function.

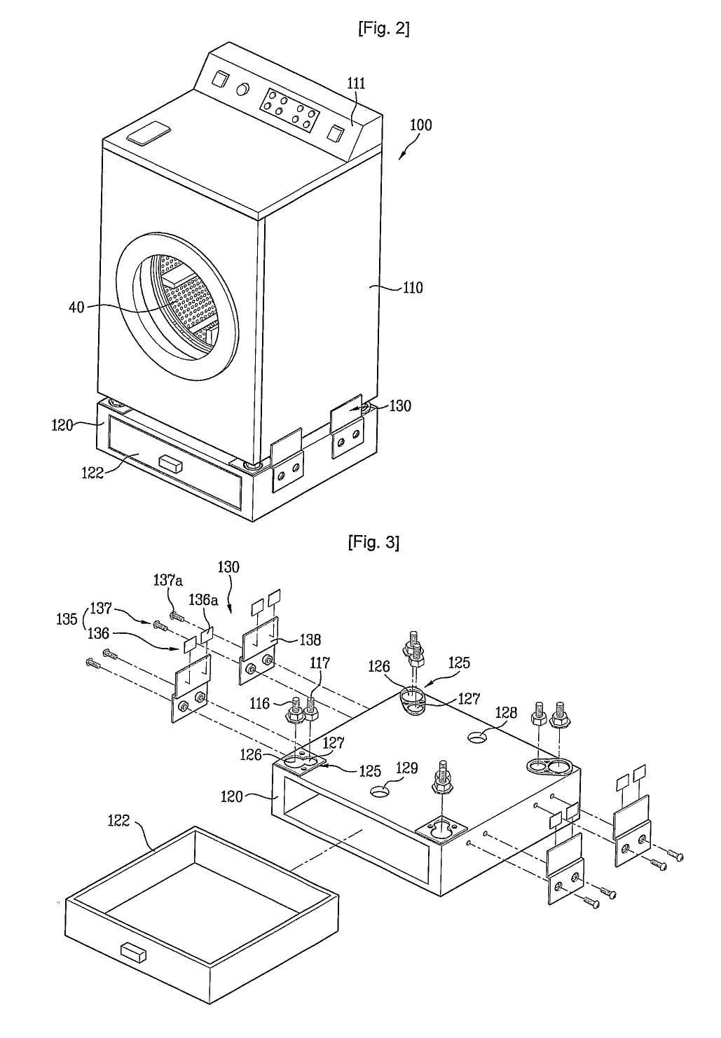

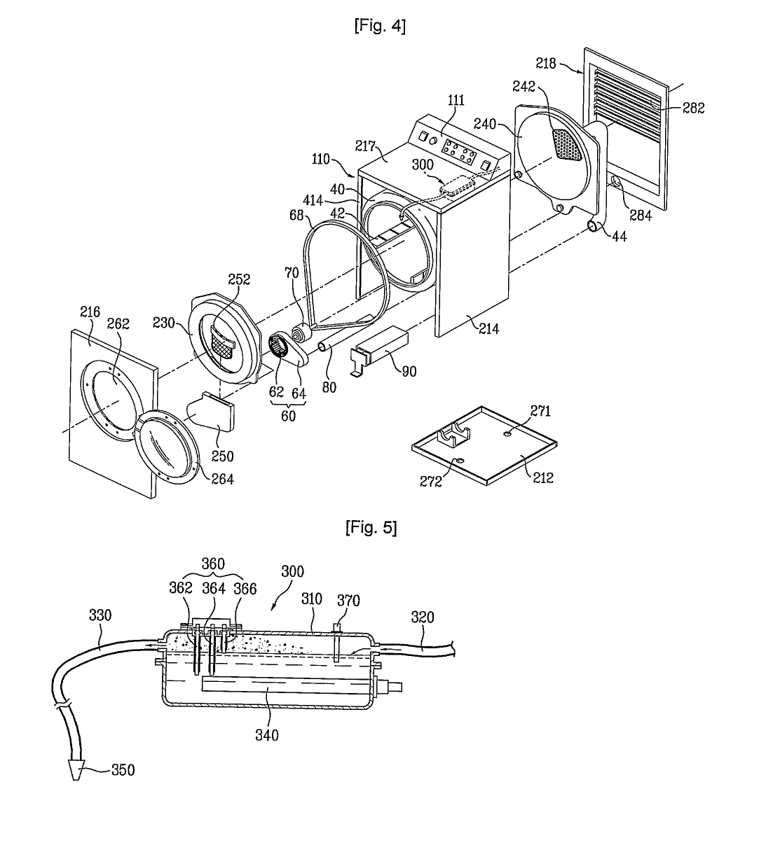

Hereinafter, the multiple laundry treating machine according to the present invention will be described in detail with reference to FIGS. 2 and 3. For the convenience of description, the following description will be given in conjunction with the case in which the multiple laundry treating machine is a drying machine.

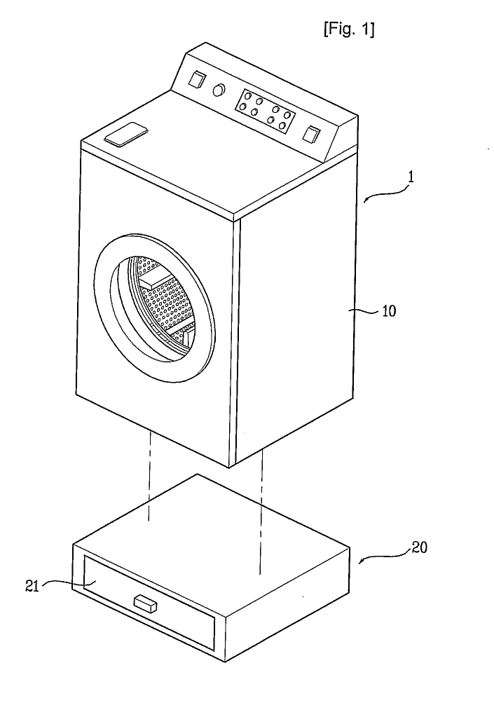

The multiple laundry treating machine may have the same outer structure as a drying machine including a base 20, as shown in FIG. 1. However, the multiple laundry treating machine of the present invention is different from the drying machine in that the base not only functions as a simple base, but also functions as an supplemental laundry treating device. The multiple laundry treating machine of the present invention is also different from the drying machine in that it includes a joining means 130 for stably coupling the supplemental laundry treating device to the laundry treating machine. Thus, the multiple laundry treating machine according to the present invention can perform multiple functions including not only a function as a drying machine, but also a function as an supplemental laundry treating device.

In accordance with the present invention, an supplemental body 120 is provided at one side of a body 110, as shown in FIG. 2. In the interior of the body 110, a laundry holding part for holding laundry, for example, a drum 40, is provided.

As show in FIG. 2, the supplemental body 120 may be located under the body 110. Alternatively, the supplemental body 120 may be located over the body 110. In the latter case, a controller for the laundry treating machine, in particular, a control panel 111, may be provided at a front surface of the body 110.

The supplemental body 120 may be provided at one side of the body 110. However, it is preferred that the supplemental laundry treating device is provided over or under the body 110, taking into consideration utilization of space and design.

As shown in FIGS. 2 and 3, the supplemental body 120 is defined therein with a space for holding laundry, in accordance with the present invention. The multiple laundry treating machine according to the present invention also includes the joining means 130 as described above. The joining means 130 functions to couple the body 110 and supplemental body 120. The supplemental body 120 supports the body 110 on a floor.

Hereinafter, the joining means 130 for the body 110 and supplemental body 120 will be described in detail with reference to FIG. 3.

As shown in FIG. 3, in accordance with the present invention, the joining means 130 may include leg supporters 125 mounted on the top of the supplemental body 120, to support side surfaces of lower legs 116 and 117 mounted to the bottom of the body 110.

For reference, FIG. 3 shows the provision of an inlet 128 and an outlet 129 for communicating the interior of a drawer slidably fitted in the supplemental body 120 and the interior of a drum provided in the body 110. That is, the illustrated structure is a structure in which the body 110 and supplemental body 120 share air or steam with each other. In this case, steam may be supplied through the inlet 128. Alternatively, steam may be supplied through a separate steam inlet (not shown).

Each leg supporter 125 comprises a panel formed with a first seating hole 126 for providing a seat for one leg 116 included in the body 110 in the case in which the body 110 is used for a washing/drying machine, and a second seating hole 127 for providing a seat for one leg 117 included in the body 110 in the case in which the body 110 is used for a drying machine. Each leg supporter 125 is fixed to the top of the supplemental body 120 by means of screws. Here, the washing/drying machine and drying machine are examples of laundry treating machines, in which the outer size of the washing/drying machine is larger than that of the drying machine.

The leg supporters 125 are fixed to respective corners of the top of the supplemental body 120. In each of the leg supporters 125 fixed to the front corners of the supplemental body 120, the first and second seating holes 126 and 127 are connected to each other. On the other hand, in each of the leg supporters 125 fixed to the rear corners of the supplemental body 120, the first and second seating holes 126 and 127 are separated from each other. In accordance with these structures, it is possible to easily achieve the seating of the legs 116 for the washing/drying machine.

In each leg supporter 125, the first seating hole 126 is provided outside the second seating hole 127 along a diagonal line on the bottom of the body 110. This is because, typically, the body of the washing/drying machine is larger than the body of the drying machine.

The joining means 130 includes joining members 138 mounted to opposite side surfaces of the body 110 of the washing/drying machine or drying machine and opposite side surfaces of the supplemental body 120, and fastening members 135 for fixing the joining members 138 to the opposite side surfaces of the body 110 of the washing/drying machine or drying machine and opposite side surfaces of the supplemental body 120.

As shown in FIG. 3, the joining means 130 may include at least two joining members 138 each coupling the adjacent side surfaces of the supplemental body 120 and body 110, each of which has a hexahedral shape.

In addition to the above-described configuration, the joining means 130 may further include third joining member (not shown) for coupling the rear surfaces of the supplemental body 120 and the body 110 of the laundry treating machine.

The joining means 130 may be configured to cope with a variation in the height of the washing/drying machine legs 116 or drying machine legs 117.

Each fastening member 135 includes a first fastening member 136 for fixing an upper portion of the associated joining member 138 to a lower portion of the side surface of the body 110 of the washing/drying machine or drying machine, to which the joining member 138 is mounted, and a second fastening member 137 for fixing a lower portion of the joining member 138 to an upper portion of the side surface of the supplemental body 120, to which the joining member is mounted.

At least one of the first and second fastening members 136 and 137 may comprise a member coated, at opposite surfaces thereof, with an adhesive material, for example, a double-sided tape.

Alternatively, at least one of the first and second fastening members 136 and 137 may comprise a fastener such as a screw. Where screws are used for each fastening member 135, the associated joining member 138 preferably has fastening holes formed through the upper portion of the joining member 138 while being spaced apart from each other by a certain distance. Of course, the joining means for coupling the body 110 and supplemental body 120 may have various configurations different from the above-described configuration.

Meanwhile, the base (“212” in FIG. 4) of the body 110 is formed with through holes (“271” and “272” in FIG. 4) respectively communicating with the inlet 128 and outlet 129. When the body 110 and supplemental body 120 are coupled, the inlet 128 and through hole 271 should be aligned with each other, and the outlet 129 and through hole 272 should be aligned with each other. The alignment can be easily achieved through the coupling of the legs 116 and 117 of the body 110 to the first and second seating holes 126 and 127.

In the present invention, it is preferred that the volume of the supplemental body 120 be smaller than the volume of the body 110 of the laundry treating machine, to which the supplemental body 120 is coupled. This is because the supplemental body is adapted to perform supplemental functions for the laundry treating machine in the present invention.

Where the supplemental body 120 functions as a base for the body 110 of the laundry treating machine, it is preferred that at least one of the lateral and longitudinal widths of the supplemental body 120 be equal to or longer than that of the body 110, taking into consideration the stability and appearance design of the multiple laundry treating machine 100. However, where the supplemental body 120 is coupled to the top of the body 110, it is preferred that at least one of the lateral and longitudinal widths of the supplemental body 120 be equal to or shorter than that of the body 110.

Hereinafter, a preferred embodiment of the present invention will be described in detail with reference to FIG. 4. In the illustrated embodiment, the body 110 is a body of an exhaustion type drying machine.

FIG. 4 is an exploded perspective view of an exhaustion type drying machine, to which the present invention is applied.

In the body 110, which forms an outer structure of the drying machine, a rotatable drum 40 is installed. A motor 70 and a belt 68 for drying the drum 40 are also provided in the body 110. At certain positions of the body 110, a heater 90 and a drying passage 44 are provided. The heater 90 functions to heat air, to generate hot air. The drying passage 44 functions to supply the hot air generated by the heater 90 to the drum 40. An air discharge passage 80 is also formed in the drum 40, to discharge, from the drum 40, humid air generated in accordance with heat exchange of the hot air with laundry in the drum 40. A blowing fan 60 is also installed in the drum 40, to suck the humid air.

The heater 171 may have various types, for example, an electrical type, a gas type, etc.

A steam supply unit 300 is installed at a certain position of the body 110, to generate high-temperature steam. Although an indirect drive type, in which the motor 70 and belt 68 are used to rotate the drum 40, has been described in this embodiment, the present invention is not limited thereto. That is, a direct drive type, in which a motor is directly connected to a rear wall of the drum 40, to directly rotate the drum 40, may be applied to the present invention.

Hereinafter, the above-described constituent elements will be described in more detail.

The body 110, which forms the outer structure of the drying machine, includes a base 212 forming the bottom of the body 110, a pair of side covers 214 extending vertically from the base 212, a front cover 216 and a rear cover 218 respectively installed at front and rear sides of the side covers 214, and a top cover 217 provided over the side covers 214. The control panel 111, which includes various operating switches, is typically provided on the top cover 217 or front cover 216. A door 264 is mounted to the front cover 216. A louver 282 is provided at the rear cover 218, to introduce ambient air into the body 110. A discharge hole 284 is also provided at the rear cover 218, as a passage for finally outwardly discharging air from the drum 40

The interior of the drum functions as a drying chamber, in which a drying operation is carried out. It is preferred that a lift 42 be installed in the drum, to drop laundry after raising the laundry such that the laundry is turned over, and thus to achieve an enhancement in drying efficiency.

Meanwhile, a front supporter 230 and a rear supporter 240 are installed between the drum 40 and the body 110 (the front cover 216 and rear cover 218). The drum 40 is rotatably installed between the front supporter 230 and the rear supporter 240. Sealing members (not shown) are fitted between the front supporter 230 and the drum 40 and between the rear supporter 240 and the drum 40, respectively, to prevent fluid leakage. That is, the front supporter 230 and rear supporter 240 close the front and rear ends of the drum 40, to define the drying chamber in the drum 40. The front supporter 230 and rear supporter 240 also function to support the front and rear ends of the drum 40.

An opening is formed through the front supporter 230, to communicate the drum 40 with the outside of the drying machine. The opening is selectively opened or closed by the door 264. A lint duct 250, which is a passage for outwardly discharging air from the drum 40, is connected to the front supporter 230. A lint filter 252 is installed in the lint duct 250. One side of the blowing fan 60 is connected to the lint duct 250. The other side of the blowing fan 60 is connected to the air discharge passage 80. The air discharge passage 80 communicates with an air discharge hole 284 provided at the rear cover 218. Accordingly, when the blowing fan 60 operates, air present in the drum 40 is outwardly discharged from the drum 40 via the lint duct 250, air discharge passage 80, and air discharge hole 284. During this operation, foreign matter such as lint is filtered by the lint filter 252. Typically, the blowing fan 60 includes a fan 62, and a fan housing 64.

An opening 242, which is constituted by a plurality of through holes, is formed at the rear supporter 240. A drying passage 44 is connected to the opening 242. The drying passage 44 communicates with the drum 40, to function as a passage for supplying hot air to the drum 40. To this end, the heater 90 is installed at a certain position in the drying passage 44.

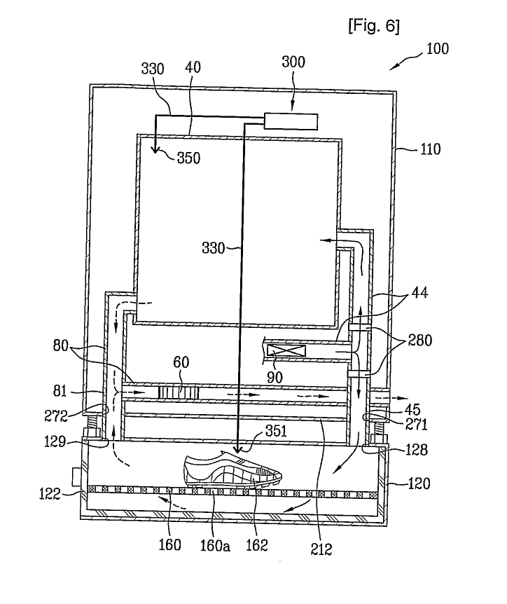

Meanwhile, a steam supply unit 200 is installed at a certain position of the body 110, to generate steam and to supply the generated steam to the interior of the drum 40. Hereinafter, the steam supply unit 300 will be described in detail with reference to FIG. 5.

The steam supply unit 300 includes a water tank 310 for containing water therein, a heater 340 mounted in the water tank 310, a water level sensor 360 for measuring the water level of the steam supply unit 300, and a temperature sensor 370 for measuring the temperature of the steam supply unit 300. Typically, the water level sensor 360 includes a cannon electrode 362, a low-water-level electrode 364 and a high-water-level electrode 366. Accordingly, the water level sensor 630 senses a high water level or a low water level in accordance with whether electrical connection is established between the cannon electrode 362 and the high-water-level electrode 366 or between the cannon electrode 362 and the low-water-level electrode 364.

A water supply hose 320 for supplying water is connected to one side of the steam supply unit 300. A steam hose 330 for discharging steam is connected to the other side of the steam supply unit 300. Preferably, a steam nozzle 350 is provided at a free end of the steam hose 330. Typically, one end of the water supply hose 320 is connected to an external water supply source such as a city water tap. The free end of the steam hose 330 or steam nozzle 350, namely, the steam discharge port of the steam hose 330, is disposed at a certain position in the drum 40, to spray steam into the interior of the drum 40.

Although the steam supply unit 300, which operates in such a manner that a certain amount of water contained in the water tank 310 is heated using the heater 340, to generated steam (hereinafter, referred to as a “barrel heating system”), has been described in this embodiment, other steam supply units may be used in the present invention, as long as they can generate steam. For example, a system, in which a heater is installed directly around a water supply hose, through which water passes, in order to heat water without containing the water in a separate space (hereinafter, referred to as a “pipe heating system”), may be used.

The steam supply unit 300 may also be configured to allow the user to manually supply water to the steam supply unit 300. For example, the user manually pours water into a separate tank (not shown), and connects the tank to the water supply hose 320, to enable the generation of steam in the steam supply unit 300. The tank may be separable from the body 110. A pump (not shown) may be provided at the water supply hose 320 between the tank and the water tank 310, to selectively supply water for the generation of steam to the water tank 310.

Heretofore, the body 110 and the detailed configuration installed in the body 110, which mainly enable treatment of laundry, in the multiple laundry treating machine 100 according to the present invention, have been described.

As described above, the multiple laundry treating machine according to the present invention further includes the supplemental body 120 for an supplemental laundry treatment. A space for holding laundry is defined in the supplemental body 120. The laundry holding space may be a drawer space defined in the drawer 21, as shown in FIGS. 2 and 3.

Hereinafter, the relation between the supplemental body 120 and the body 110 will be described in detail with reference to FIG. 6.

As described above in conjunction with FIG. 6, an air supply unit for forcibly supplying air to the interior of the drum is installed in the body 110. The air supply unit includes the heater 90 for heating air, and the blowing fan 60 for blowing air. The air supply unit also includes a drying passage 44 for guiding air to be introduced into the drum 40, and the air discharge passage 80 for guiding air to be discharged out of the drum 40

The air supply unit not only forcibly supplies air to the drum 40, but also forcibly supplies air to the interior of the supplemental body 120, namely, the interior of a drawer 122. To this end, the air supply unit includes an supplemental drying passage 45 and an supplemental air discharge passage 81.

The supplemental drying passage 45 may be branched from the drying passage 44. One end of the supplemental drying passage 45 is connected to the through hole 271 formed through the base 212. The through hole 271 communicates with the inlet 128 formed through the top of the supplemental body 120. Accordingly, drying air can be introduced into the interior of the drawer 122.

The supplemental air discharge passage 81 may be branched from the air discharge passage 80. One end of the supplemental air discharge passage 81 branched from the air discharge passage 80 is connected to the through hole 272 formed through the base 212. The through hole 272 communicates with the outlet 129 formed through the supplemental body 120. Accordingly, air present in the interior of the drawer 122 can be outwardly discharged.

Of course, the outlet 129 may not be connected to the through hole 272. That is, air present in the interior of the drawer 122 may be outwardly discharged directly through the outlet 129. In this case, the supplemental air discharge passage 81 may be dispensed with.

It is preferred that the heater 90 be provided in the drying passage 44 upstream of the branching point of the supplemental drying passage 45. In this case, it is possible to supply hot air to both the drum 40 and the drawer 122, using only one heater. Of course, when the heater 90 does not operation, air of roan temperature will be supplied.

It is also preferred that the blowing fan 60 be provided in the air discharge passage 80 downstream of the branching point of the supplemental air discharge passage 81. In this case, it is possible to supply hot air to both the drum 40 and the drawer 122, using only one blowing fan.

The multiple laundry treating machine 100 according to the present invention not only can supply air to the drum, but also can supply air to the interior of the drawer. If necessary, it is possible to supply air only to the drum, or only to the drawer. Of course, it is possible to supply air to both the drum and the drawer. To this end, means for selectively opening/closing the drying passage 44 and supplemental drying passage 45, for example, dampers 280, may be provided in the drying passage 44 and supplemental drying passage 45.

The multiple laundry treating machine 100 according to the present invention may include the steam supply unit 300, which is provided in the body 110, to supply steam to the drum 40 and drawer 122. The steam supply unit 300 has been described.

The steam supply unit 300 may further include a steam nozzle 351 for spraying steam into the drawer, in addition to the steam nozzle 350 for spraying steam into the drum. Accordingly, it is possible to supply steam to the drum and drawer through the steam nozzles 350 and 351.

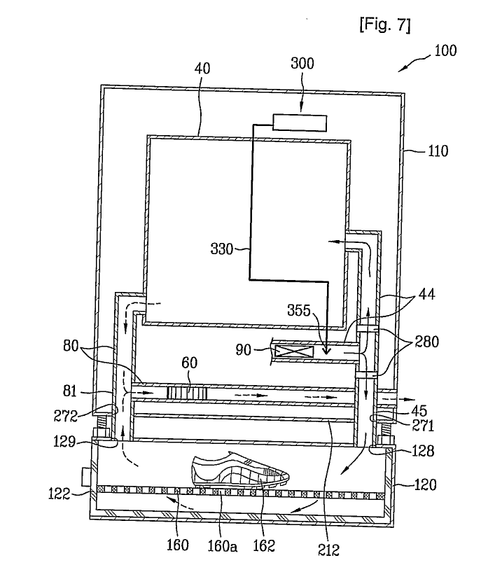

Different from the above-described case, the steam supply unit 300 may include only one steam nozzle 355 to supply steam to the drum and drawer, as shown in FIG. 7. In this case, the steam nozzle 355 of the steam supply unit 300 may be configured to spray steam into the drying passage 44 upstream of the branching point of the supplemental drying passage 45. That is, when the steam nozzle 355 sprays steam into the drying passage 44, the sprayed stream will be supplied to the drum and drawer via the drying passage 44 and supplemental drying passage 45. In this case, it is preferred that the fan 60 operates simultaneously with the supply of steam. In this case, it is also unnecessary to provide a separate steam inlet at the supplemental body 120. This is because steam is supplied to the drawer via the supplemental drying passage 45.

The reason why steam is supplied to the drum and drawer in accordance with the present invention is to refresh laundry. That is, high-temperature steam is supplied to the interior of the drum and the interior of the drawer, in order to achieve removal of creases, static electricity, and odor from laundry, and sterilization of laundry. Accordingly, it may be preferred that heated drying air be supplied to the interiors of the drum and drawer, after the supply of steam. In this case, it is possible to remove moisture remaining in laundry, for example, clothes, and thus to allow the user to wear the clothes.

In accordance with the present invention, the operations of the heater 90, blowing fan 60, damper 280, and steam supply unit 300 are controlled by the controller (not shown). It is preferred that the controller be provided on the front surface of the body 110. The controller may include the control panel 111, which is operated by the user.

Thus, it is possible to forcibly supply air to the interiors of the drum and drawer in a selective manner under the control of the controller. It is also possible to control the temperature of the air and the supply time of the air under the control of the controller. Also, it is possible to selectively supply steam to the interiors of the drum and drawer under the control of the controller.

In the present invention, it is preferred that the heater 90 be a capacity-variable heater capable of varying the temperature of air heated by the heater. This is because specific clothes exhibit a low resistance to heat, and in particular, shoes made of a rubber material exhibit a low resistance to heat. The capacity of the heater 80 may be controlled through the controller.

Meanwhile, a rack 160 may be provided in the drawer 122 such that the interior of the drawer 122 is partitioned into upper and lower spaces by the rack 160. The upper and lower spaces communicate with each other. Laundry 162 may be laid on the rack 160. The rack 160 functions to allow air supplied to the laundry 162 to be smoothly discharged.

It is preferred that a plurality of pores 160a be formed through the rack 160. In this case, air present in the upper portion of the drawer can be introduced into the lower portion of the drawer through the pores 160a.

The rack 160 may be inclinedly provided. In this case, it is preferred that the rack 160 be downwardly inclined toward a position where air is introduced. In this case, accordingly, air can be uniformly supplied to the laundry 162 laid on the rack 160.

In accordance with a preferred embodiment of the present invention, a method for controlling the multiple laundry treating machine 100 is provided. The control method includes a first step of forcibly supplying air to the drum, to dry laundry held in the drum, and a second step of forcibly supplying air to the interior of the drawer, to dry laundry held in the drawer. The supplied air may be air heated to a high temperature, namely, hot air.

The first and second steps may be simultaneously executed, or may be selectively executed.

In the drawer, laundry, such as shoes or hats, as well as general laundry, can be dried. However, the material of shoes may be natural rubber or synthetic rubber exhibiting a low resistance to heat. Accordingly, it is preferred that the temperature and supply time of air supplied to the interior of the supplemental body be controlled to be variable. In this case, the user may operate the control panel 111 to select a desired operation mode.

For example, the operation mode may include a shoes drying mode and a clothes drying mode. It is preferred that, when the user selects the shoes drying mode, high-temperature air be supplied for a short period of time at the second step. On the other hand, it is preferred that, when the user selects the clothes drying mode, air having a relatively low temperature be supplied for a long period of time at the second step. Of course, the clothes drying mode may be further divided into sub-modes in accordance with clothes exhibiting a low resistance to heat, such as silk or wool, and clothes exhibiting a high resistance to heat, such as cotton.

Meanwhile, in the illustrated embodiment, the control method may further include a step of supplying steam to achieve refresh of laundry. In order to execute the refresh, the operation mode should include a refresh mode.

When the user selects the refresh mode, a step of supplying steam to the interior of the drawer is executed. If necessary, a step of forcibly air to the interior of the drawer may be executed after the execution of the steam supplying step. Of course, the supplied air may be heated air or air of roan temperature. The air supplying step may be executed during or after the execution of the steam supplying step.

When the user selects the refresh mode, refresh of laundry is achieved by the supplied stream. It is also possible to completely remove moisture remaining in the laundry by the supplied air.

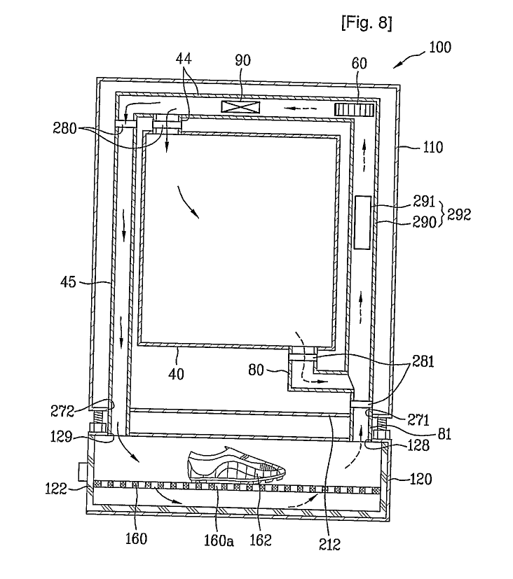

Hereinafter, another embodiment of the multiple laundry treating machine according to the present invention will be described with reference to FIG. 8. A large part of this embodiment is identical to that of the above-described embodiment, so that no description thereof will be given.

Although the above-described embodiment is an exhaustion type drying machine, in which no circulation of air is carried out, this embodiment is a condensation type drying machine, in which air is circulated.

In order to form an air circulation passage, the air supply unit in this embodiment includes a condensing unit 292 for removing moisture from air. The condensing unit 292 includes a condensing passage 290, and a condenser 291.

Air discharged from the drum 40 through the air discharge passage 80 and air discharged from the drawer 122 through the supplemental air discharge passage 81 are guided to the condensing passage 290. Moisture contained in the air is removed by the condenser 292 in the condensing passage 290. The condensing passage 290 is connected to the drying passage 44, to guide air to be introduced into the drying passage 44.

Since the blowing fan 60 and heater 90 are provided in the drying passage 44, it is possible to circulate air, and to heat air, and thus to generate hot air. The hot air is again supplied to the drum and drawer via the drying passage 44 and supplemental drying passage 45, respectively.

Meanwhile, the outlet 128 of the supplemental body may not be connected to the supplemental air discharge passage 81. In this case, humid air discharged out of the drawer can be directly discharged to the outside of the drawer. However, it is preferred that the outlet 128 be connected to the supplemental air discharge passage 81, in order to enable the air circulation and to achieve an enhancement in the introduction efficiency of drying air.

It is also preferred that dampers 281 be provided in the air discharge passage 80 and supplemental air discharge passage 81, to selectively open/close the passages 80 and 81.

Similarly to the above-described embodiment, it is possible, in this embodiment, to supply steam to the interiors of the drum and drawer through the steam supply unit 300. The detailed configuration for the supply of steam may be identical to that of the above-described embodiment.

Similarly to the above-described embodiment, a controller may be included in this embodiment, to apply the same control method as the above-described embodiment to this embodiment.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

In accordance with the present invention, it is possible to achieve a convenience in use and to save energy by the provision of an supplemental laundry treating machine capable of treating a small amount of laundry without driving the laundry treating machine in a large capacity.

It is also possible to easily dry laundry including shoes, hats, etc. which are difficult to be dried using a conventional drum type drying machine. Also, it is possible to utilize an supplemental space in a conventional laundry treating machine, for example, a base, as an supplemental laundry treating device.

Thus, in accordance with the present invention, it is possible to provide an inexpensive multiple laundry treating machine achieving a maximal use of space, and thus a convenience in use.

1. A multiple laundry treating machine comprising:
a body formed with a laundry holding part for holding laundry;
an supplemental body provided at one side of the body, the supplemental body having a volume and a height respectively smaller than a volume and a height of the body, and having a laundry-holding space defined in the supplemental body to hold laundry; and
an air supply unit provided in the body, to supply air to an interior of the body and an interior of the supplemental body.

2. The multiple laundry treating machine according to claim 1, wherein the air supply unit comprises:
a blowing fan for blowing air; and
a heater for heating air blown by the blowing fan.

3. The multiple laundry treating machine according to claim 2, further comprising a joining means for securing the supplemental body to one side of the body.

4. The multiple laundry treating machine according to claim 3, wherein the joining means comprises:
a plurality of joining members each provided to sides both of the body and the supplemental body; and
fastening members for fastening the joining members to the sides both of the body and the supplemental body.

5. The multiple laundry treating machine according to claim 4, wherein each fastening member comprises:
a first fastening member for fastening an upper portion of the joining member to the side of the body; and
a second fastening member for fastening a lower portion of the joining member to the side, of the supplemental body.

6. The multiple laundry treating machine according to claim 5, wherein at least one of the first and second fastening members comprises a tape.

7. The multiple laundry treating machine according to claim 5, wherein at least one of the first and second fastening members comprises a screw.

8. The multiple laundry treating machine according to claim 2, wherein the air supply unit further comprises a drying passage and an supplemental drying passage for guiding air to be introduced into the laundry holding part of the body and the laundry-holding space of the supplemental body, respectively.

9. The multiple laundry treating machine according to claim 8, wherein the supplemental drying passage is branched from the drying passage.

10. The multiple laundry treating machine according to claim 9, wherein the heater is provided in the drying passage upstream of a branching point of the supplemental drying passage.

11. The multiple laundry treating machine according to claim 10, wherein dampers are provided in the drying passage and the supplemental drying passage, respectively, to open/close the drying passage and the supplemental drying passage.

12. The multiple laundry treating machine according to claim 8, wherein the supplemental body is formed with an inlet connected to the supplemental drying passage, to allow air to be introduced into the laundry-holding space.

13. The multiple laundry treating machine according to claim 8, wherein the air supply unit further comprises an air discharge passage for guiding air to be discharged out of the laundry holding part.

14. The multiple laundry treating machine according to claim 13, wherein the blowing fan is provided in the air discharge passage.

15. The multiple laundry treating machine according to claim 13, wherein the supplemental body is formed with an outlet for discharging air out of the laundry-holding space.

16. The multiple laundry treating machine according to claim 15, wherein the air supply unit further comprises an supplemental air discharge passage connected to the outlet, to guide air to be outwardly discharged.

17. The multiple laundry treating machine according to claim 16, wherein the supplemental air discharge passage is branched from the air discharge passage.

18. The multiple laundry treating machine according to claim 17, wherein the blowing fan is provided in the air discharge passage downstream of a branching point of the supplemental air discharge passage.

19. The multiple laundry treating machine according to claim 9, further comprising a steam supply unit for supplying steam to the laundry holding part and to an interior of the supplemental body.

20. The multiple laundry treating machine according to claim 19, wherein the steam supply unit is provided at one side of the body.

21. The multiple laundry treating machine according to claim 19, wherein the steam supply unit comprises a steam nozzle for supplying steam to the drying passage at a position upstream of a branching point of the supplemental drying passage.

22. The multiple laundry treating machine according to claim 19, wherein the steam supply unit comprises steam nozzles for spraying steam into the laundry holding part and into an interior of the supplemental body, respectively.

23. The multiple laundry treating machine according to claim 1, wherein the supplemental body is located under the body.

24. The multiple laundry treating machine according to claim 23, wherein the laundry holding part comprises a selectively-rotatable drum.

25. The multiple laundry treating machine according to claim 23, wherein the laundry-holding space has a form of a drawer capable of being forwardly drawn from the front of the supplemental body.

26. The multiple laundry treating machine according to claim 25, wherein the drawer is provided with a rack therein to allow laundry to be placed thereon, the rack dividing an interior of the drawer into upper and lower spaces communicating with each other.

27. The multiple laundry treating machine according to claim 19, further comprising a controller for controlling the air supply unit to selectively supply air to the laundry holding part and to the interior of the supplemental body, and controlling the steam supply unit to selectively supply steam to the laundry holding part and to the interior of the supplemental body.

28. The multiple laundry treating machine according to claim 27, wherein the controller performs a control operation to vary a temperature and a supply time of the air supplied to the interior of the supplemental body in accordance with an operation mode selected by a user.

29. The multiple laundry treating machine according to claim 27, wherein the controller performs a control operation to execute the supply of steam before the supply of air to the interior of the supplemental body in accordance with an operation mode selected by a user.

30. A method for controlling a multiple laundry treating machine including a body provided with a selectively-rotatable drum, and an supplemental body provided at one side of the body, the supplemental body having a volume and a height respectively smaller than a volume and a height of the body, and having a laundry-holding space defined in the supplemental body to hold laundry, comprising:
selecting an operation mode by a user;
supplying air to the drum; and
supplying air to the laundry-holding space.

31. The method according to claim 30, wherein the step of supplying air to the drum and the step of supplying air to the laundry-holding space are simultaneously or selectively executed in accordance with the operation mode selected by the user.

32. The method according to claim 31, further comprising:
supplying steam to the laundry-holding space before or during the execution of the step of supplying air to the laundry-holding space, in accordance with the operation mode selected by the user.

33. The method according to claim 31, wherein a temperature and a supply time of the air supplied to an interior of the supplemental body at the step of supplying air to the laundry-holding space are varied in accordance with the operation mode selected by the user.

34. The method according to claim 33, wherein the operation mode comprises a shoes drying mode and a clothes drying mode.

35. The method according to claim 34, wherein the temperature of the air supplied to the interior of the supplemental body when the user selects the shoes drying nude is higher than the air temperature when the user selects the clothes drying mode, and the air supply time when the user selects the shoes drying mode is shorter than the air supply time when the user selects the clothes drying mode.
